(19) United States
(12) Patent Application Publication
(10) Pub. No.: US 2015/0029892 A1
(43) Pub. Date: Jan. 29, 2015

(54) APPARATUS FOR DETECTING A PERIODICITY, A METHOD THEREOF AND A RECORDING MEDIUM THEREOF

(71) Applicant: IDEAWARE INC., Seongnam-si (KR)

(72) Inventor: Yang Myung CHA, Yongin-si (KR)

(73) Assignee: IDEAWARE INC., Seongnam-si (KR)

(21) Appl. No.: 14/444,033

(22) Filed: Jul. 28, 2014

(30) Foreign Application Priority Data
Jul. 26, 2013 (KR) 10-2013-0088633
Jul. 26, 2013 (KR) 10-2013-0088672
Jul. 26, 2013 (KR) 10-2013-0088675

(51) Int. Cl. H04L 12/26

(52) U.S. Cl. CPC H04L 43/10; H04L 43/04
USPC 370/253

(57) ABSTRACT

A device for detecting periodicity includes a collection unit for collecting or capturing a plurality of packets for mutually transceiving between a plurality of wireless terminal and a plurality of servers through a communication network; a preprocessing unit for connecting the packets and packet collection or capture time information collected or captured by the collection unit to each wireless terminals IP and servers IP/PORT and mapping the connected them; a modeling processing unit for processing at least one data modeling and grouping for each packet generation patterns, for the mapped packets; a pattern detection unit for detecting similar data models within the margin of defined error as repetition generation pattern types by mutual lengths between a plurality of data models grouped for each packet generation pattern; and a periodicity detection unit for determining periodic section when the detected repetition generation pattern types are successively generated above n times and the sections successively generated above n times occupy above predetermined rate for total sections.

### BACKGROUND OF THE INVENTION

1. Technical Field

The present invention detects the main cause of wireless network load, that is, periodicity for each application.

2. Description of the Related Art

After smartphones have been supplied, patterns using a wireless terminal for individuals are abruptly changed from voice communication to data communication.

In FIG. 1 shown as mobile (wireless) data traffic index, mobile traffics are expected to increase to 26 times in the next 10 to 15 years, and mobile data amount of 15 MB used by individuals per day has been used in 2010 but mobile data amount of 1 GB will be used in 2020.

The increase of the mobile traffics directly effects on profitability and service quality of the mobile-service company and accompanies a service provider, that is, a mobile-service company's equipment expansion, and therefore profit aggravation is inevitable and a user using a mobile network has service dissatisfaction due to data communication velocity delay.

Therefore, the mobile-service company must effectively use network infra to reduce investment burden and to guarantee service quality and an alternative guaranteeing predictability and real-time control is needed due to the limits of current solutions.

In more detail, as shown in FIG. 2, periodic data transmission of various applications installed at the wireless terminals is the main cause of the mobile network jam.

For example, in order to connect one data polling application to the servers, many data communications such as location confirm for base stations are preceded, and the traffics for connecting to application servers are caused even after connecting to the communication network. When the wireless terminal requests and receives something to/from the servers to update data such as contents, data communication may be performed by a polling scheme. However, on too frequently defining periodic information inquiry, that is, the period of the polling due to ignorance of update time for data on the servers, the load at a mobile network may be caused.

Further, the applications communicating with the servers connect the servers to the networks, and perform termination of the networks with the servers after transceiving data to be desired. However, on not transceiving the packets from/to the servers in a state connected to the networks, it is regarded as non-activated network connection at the servers or communication networks after a constant time and it is possible to forcibly disconnect the networks at resource cleanup dimension. When the networks are disconnected in a situation in which the applications do not want, problems are caused. In a simple chatting program, when the users A and B connect to each server to chat, the servers may transfer messages receiving from A to B or messages receiving from B to A on maintaining the network connection between A and B. When A does not chat for a while and is not disconnected from the connection at the servers or communication networks, the connection with A is already disconnected on being desired to transmit the messages to A by B such that the messages may not be transferred from the servers to A.

Therefore, although the user does not send the messages, small packets are periodically sent to the servers to keep the network connection alive. Such a packet is called a Keep Alive packet. On keeping the network connection alive and transceiving the packets of no great import between the terminals and servers by too short periods to receive the packets from the servers, the load of the mobile network may be caused due to the generation of many signals.

Further, data communication applications automatically connect to the application servers at a few dozen second to a few dozen minute interval and checks whether data to be updated are present, or transmits small packets. Since this causes many traffic on the communication network even on no updating data at the application servers and the same processes are periodically repeated, the overload may be caused on the mobile network.

### SUMMARY OF THE INVENTION

An advantage of some aspects of the invention is that it provides a device and method for detecting periodicity, and recording medium capable of disconnecting unnecessary periodic network connection for the applications installed at the wireless terminals by detecting periodic packet sections such as polling and Keep Alive on transceiving the packets between a specific server and wireless terminal in a mobile network.

According to an aspect of the invention, there is provided a device for detecting periodicity including a collection unit for collecting or capturing a plurality of packets for mutually transceiving between a plurality of wireless terminal and a plurality of servers through a communication network; a preprocessing unit for connecting the packets and packet collection or capture time information collected or captured by the collection unit to each wireless terminals IP and servers IP/PORT and mapping the connected them; a modeling processing unit for processing at least one data modeling and grouping for each packet generation patterns, for the mapped packets; a pattern detection unit for detecting similar data models within the margin of defined error as repetition generation pattern types by mutual lengths between a plurality of data models grouped for each packet generation pattern; and a periodicity detection unit for determining periodic section when the detected repetition generation pattern types are successively generated above n times and the sections successively generated above n times occupy above predetermined rate to a total unit.

The device for detecting periodicity further includes a Keep Alive determination unit for determining the periodic section as Keep Alive periodic section based on at least one of the changing or not for the ports of the packets stored into the slots present at the sections to be periodically set, the number of the packets to be transceived, and the sizes of the packets to be transceived.

The Keep Alive determination unit determines the periodic section as the Keep Alive periodic section when the ports of the packets stored into the slots present at the sections to be periodically set are not changed or the number of the packets to be transceived is below predetermined number or the sizes of the packets to be transceived are constant.

The device for detecting periodicity further includes a polling determination unit for determining the periodic section as polling periodic section based on the ports of the packets stored into the slots present at the sections to be periodically set.

The polling determination unit determines the periodic section as polling periodic section when the ports of the packets stored into the slots present at the sections to be periodically set are successively changed.

The preprocessing unit filters network control packets of a plurality of packets to be collected or captured and excludes the filtered packets, and the network control packets include at least one of TCP connection packets, network connection termination packets, resetting packets, and acknowledgement packets.

The data modeling processing unit processes data modeling using at least one of a polling model grouping for a period of changing ports of the wireless terminals, a time model grouping the packets included in predefined time interval, and a region model grouping according to packet generation distribution.

The device for detecting periodicity further includes comprising a check unit for checking domain names suitable for an IP of the servers corresponding to the periodic section using IP and domain name tables derived by DNS (Domain Name System) protocol analysis.

According to another aspect of the invention, there is provided a method for detecting periodicity including collecting or capturing a plurality of packets for mutually transceiving between a plurality of wireless terminal and a plurality of servers through a communication network; connecting the packets and packet collection or capture time information collected or captured by the collection unit to each wireless terminals IP and servers IP/PORT and mapping the connected them; processing at least one data modeling and grouping for each packet generation patterns, for the mapped packets; detecting similar data models within the margin of defined error as repetition generation pattern types by mutual lengths between a plurality of data models grouped for each packet generation pattern; and determining periodic section when the detected repetition generation pattern types are successively generated above n times and the sections successively generated above n times occupy above predetermined rate to a total unit.

Further, the present invention includes a computer-readable recording medium for recording programs to execute each step.

### BRIEF DESCRIPTION OF THE DRAWINGS

The following drawing drawings attached to the present specification illustrates an exemplary embodiment of the invention, and serves to further understand the technical idea of the invention along with a detailed description of the invention. Therefore, the invention is not limited to matters described in the drawings.

FIG. 1 shows mobile (wireless) data traffic indexes.

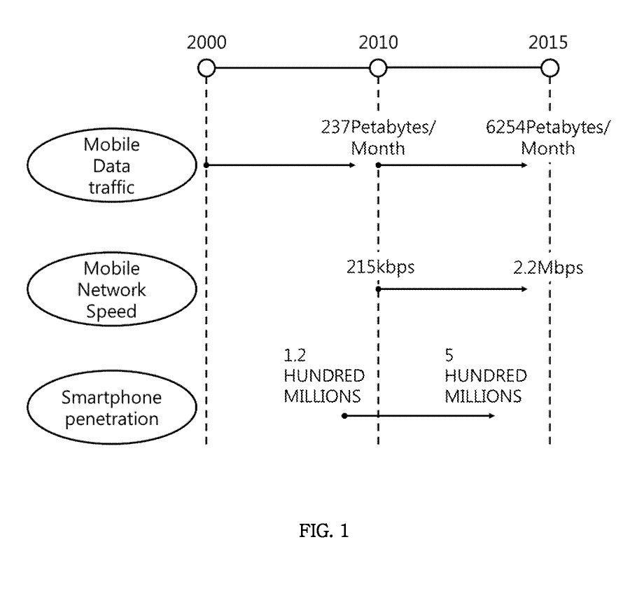

FIG. 2 shows one of main factors that may cause prior mobile network jam.

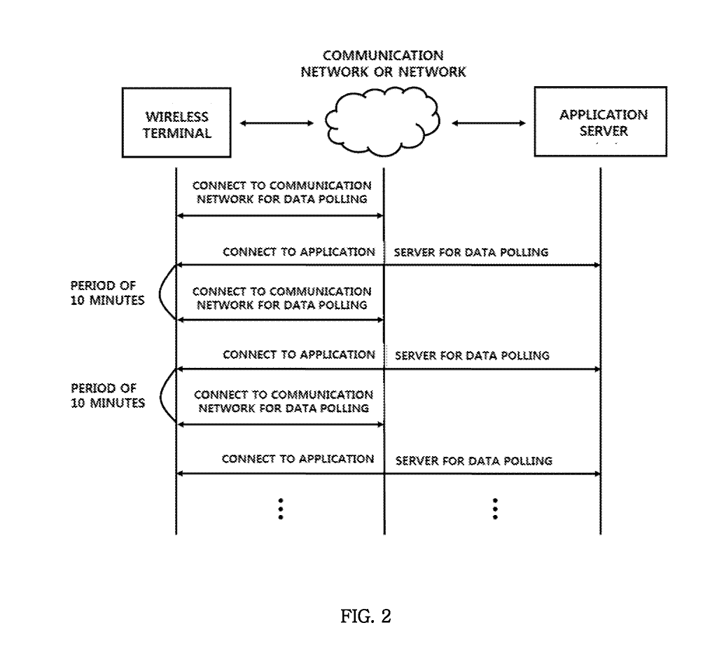

FIG. 3 shows the main configuration unit for a device for detecting periodicity according to an embodiment of the present invention.

FIG. 4 shows one embodiment showing one of preprocessing processes according to an embodiment of the present invention.

FIG. 5 shows one embodiment showing one of the preprocessing processes according to an embodiment of the present invention.

FIG. 6 shows one embodiment showing one of the preprocessing processes according to an embodiment of the present invention.

FIG. 7 shows one embodiment showing one of the preprocessing processes according to an embodiment of the present invention.

FIG. 8 shows one embodiment showing an example of filtering control packets according to an embodiment of the present invention.

FIG. 9 shows one embodiment showing an example of filtering the control packets according to an embodiment of the present invention.

FIG. 10 shows one embodiment showing a process of processing polling modeling according to an embodiment of the present invention.

FIG. 11 is one embodiment showing data models according to the embodiment of the present invention.

FIG. 12 is one embodiment showing the process of processing time modeling according to an embodiment of the present invention.

FIG. 13 is one embodiment showing the process of processing regional modeling according to an embodiment of the present invention.

FIG. 14 is one embodiment showing one of pattern detecting processes according to an embodiment of the present invention.

FIG. 15 is one embodiment showing one of the pattern detecting processes according to an embodiment of the present invention.

FIG. 16 is one embodiment showing one of the pattern detecting processes according to an embodiment of the present invention.

FIG. 17 is one embodiment showing one of the pattern detecting processes according to an embodiment of the present invention.

FIG. 18 is one embodiment showing one of the pattern detecting processes according to an embodiment of the present invention.

FIG. 19 is one embodiment showing one of the pattern detecting processes according to an embodiment of the present invention.

FIG. 20 is one embodiment showing one of the pattern detecting processes according to an embodiment of the present invention.

FIG. 21 is one embodiment showing one of periodicity detecting processes according to an embodiment of the present invention.

FIG. 22 is one embodiment showing one of the periodicity detecting processes according to an embodiment of the present invention.

FIG. 23 schematically shows the entire processes according to an embodiment of the present invention.

FIG. 24 shows the periodicity detecting processes according to an embodiment of the present invention.

FIG. 25 shows the periodicity detecting processes such as polling or keep-alive according to an embodiment of the present invention.

### DESCRIPTION OF THE PREFERRED EMBODIMENTS

Hereinabove, although the present invention is described by specific matters such as concrete components, and the like, embodiments, and drawings, they are provided only for assisting in the entire understanding of the present invention. The specified matters and embodiments and drawings such as specific apparatus drawings of the present invention have been disclosed for illustrative purposes, but are not limited thereto, and those skilled in the art will appreciate that various modifications, additions and substitutions are possible from the disclosure in the art to which the present invention belongs. In describing exemplary embodiments of the present invention, well-known functions or constructions will not be described in detail since they may unnecessarily obscure the understanding of the present invention. Further, the terminologies specifically defined in consideration of the configuration and functions of the present invention may be construed in different ways by the intention of users and operators. Therefore, the definitions thereof should be construed based on the contents throughout the specification. Therefore, the definitions thereof should be construed based on the contents throughout the specification.

It will be apparent to those skilled in the art that substitutions, modifications and variations can be made without departing from the spirit and scope of the invention as defined by the appended claims and can also belong to the scope of the invention.

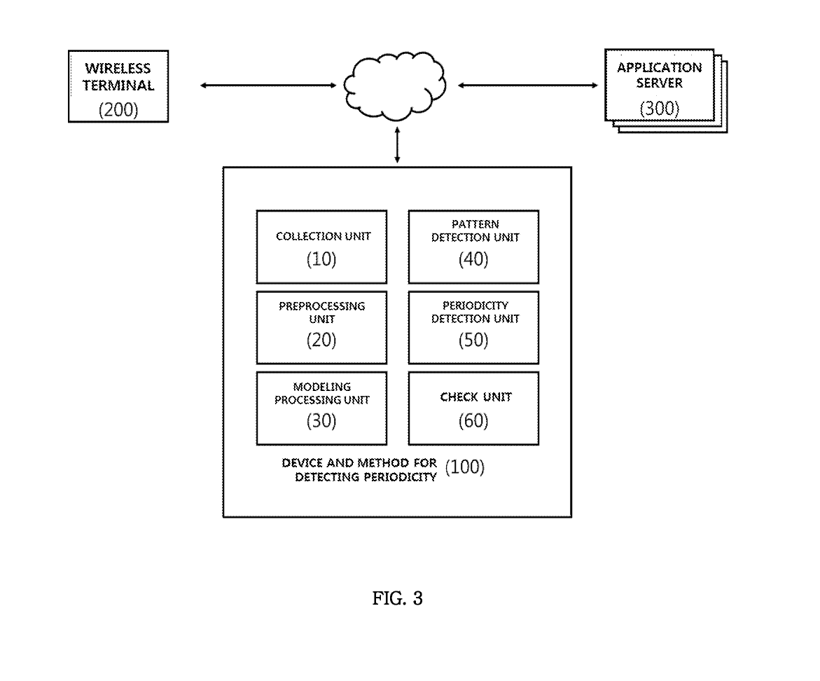

FIG. 3 shows the main configuration unit for a device 100 for detecting periodicity according to an embodiment of the present invention.

In more detail, FIG. 3 shows that a plurality of wireless terminals 200 and servers 300 are connected to a communication network or a network for transceiving packets, and shows the configurations for detecting the periodicity after collecting and capturing the packets.

Each configuration shown in FIG. 3 is the configuration for describing an embodiment of the present invention, but the present invention is not limited to technical characteristics of the embodiment shown in FIG. 3.

In an embodiment of the present invention, the device 100 for detecting periodicity collects or captures a plurality of packets for mutually transceiving between a plurality of wireless terminals 200 and servers 300 through the network, maps the collected or captured packets and packet collection or capture time information to the subject and the object of transceiving each packet, that is, each wireless terminals 200 IP and servers 300 IP/PORT by connecting them, processes at least data modeling for the mapped packets and groups the processed them for each packet generation pattern, detects similar data models within the margin of defined error as repetition generation pattern types by mutual lengths (the sum of time difference between the last packet of the previous data model and the first packet of the current data model and time difference between the first packet and last packet that belong to the current data model or time difference between the last packet of the previous data model or the first packet of the current data model or time difference between the first packet and last packet that belong to the current data model) between a plurality of data models grouped for each packet generation pattern, and determines periodic section when the detected repetition generation pattern types are successively generated above n times (n=one numeral of 2, 3, 4 . . . n) and a sum of time intervals of the repetition pattern types successively generated above n times occupy above predetermined rate to a total time.

Referring to FIG. 3, the device 100 for detecting periodicity in the embodiment of the present invention includes a collection unit 10, a preprocessing unit 20, a modeling processing unit 30, a pattern detection unit 40, a periodicity detection unit 50, and a check unit 60.

The device 100 for detecting periodicity is shown as a single device in the drawing for the description of the embodiments, but each configuration may be separated into at least one device or server.

Referring to FIG. 3, the collection unit 10 collects or captures a plurality of packets for mutually transceiving between a plurality of wireless terminals 200 and servers 300 through the communication network.

When the wireless terminals 200 communicate with the servers 300 (for game, web, chatting and YouTube) in the embodiment of the present invention, packets produced from the wireless terminals 200 are converted into TCP/IP protocol and therefore transferred to the corresponding server 300 while passing network processing apparatuses such as GGSN (Gateway GPRS SupPORT Node) or P-Gateway. Since the packets should be analyzed without causing communication problems between the wireless terminals 200 and the servers 300, the collection unit 10 duplicates the packets and it is desirable that the duplicated packets are transferred to the preprocessing unit 20. Further, communication equipments to be described below are modified for in-line processing.

The preprocessing unit 20 of the present invention connects the packets and packet collection or capture time information collected or captured by the collection unit 10 to the subject and the object of transceiving each packet, that is, each wireless terminals 200 IP and servers 300 IP/PORT and maps the connected them.

The packets transceiving between the wireless terminals 200 and servers 300 in the communication network are mixed in the packets communicating between a plurality of the wireless terminals 200 and servers 300, and therefore the packets should be firstly classified for each wireless terminals 200 communicating with the servers 300 to grasp the periodicity between the packets transceiving between a specific wireless terminal 200 and a specific server 300. Therefore, the preprocessing unit 20 maps the packets and packet collection or capture time information collected or captured by the collection unit 10 to the subject and the object of transceiving each packet, that is, each wireless terminals 200 IP and servers 300 IP/PORT by connecting them.

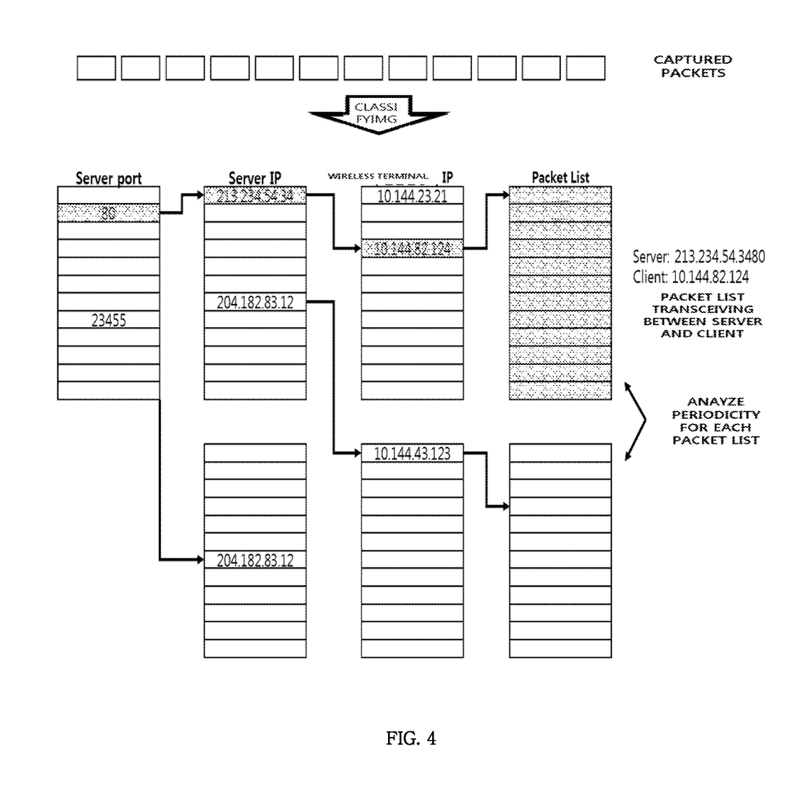

FIG. 4 to FIG. 7 shows a mapping process performed by each wireless terminals 200 IP and servers 300 IP/PORT in the preprocessing unit 20.

FIG. 4 shows that the preprocessing unit 20 connects the packets collected or captured by the collection unit 10 to the subject and the object of transceiving each packet, that is, each wireless terminals 200 IP and servers 300 IP/PORT and maps the connected them.

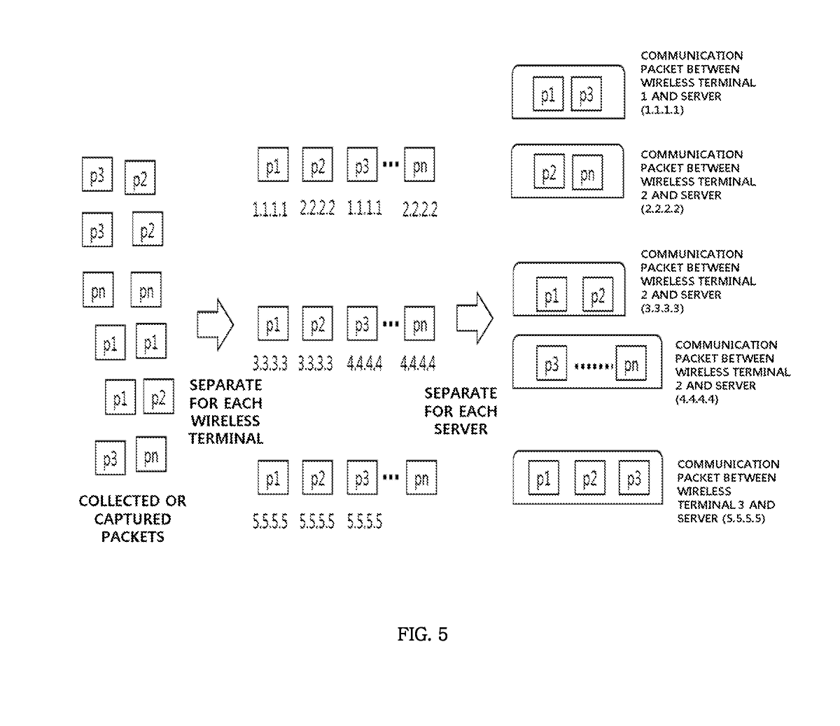

In FIG. 5, in order to classify the packets transceiving between a plurality of wireless terminals 200 and servers 300 for each specific wireless terminals 200 and servers 300 communicating with the specific wireless terminals 200, the preprocessing unit 20 may firstly classify a plurality of packets for each IP of the wireless terminals 200 and secondly classify each packet for each servers 300, using IP/PORT of packet source and IP/PORT of destination written in the packets, to send the packets from the specific wireless terminals 200 to the servers 300.

For example, on sending the packets from the wireless terminals 200 IP 1.1.1.1/PORT 10 to the servers IP 2.2.2.2/PORT 20, 1.1.1.1 is written in source field of IP header of the packets, and 2.2.2.2 is written in destination field. Similarly, when 10 is written in the source of TCP (or UDP) header, 20 is written in the destination, the source and destination are written in the packets, and the packets are transferred to various routers or switches, the packets are transferred to another routers or switches while referencing the corresponding fields of the packets and it is possible to classify whether from where do these packets come from to where are these packets going on analyzing these fields.

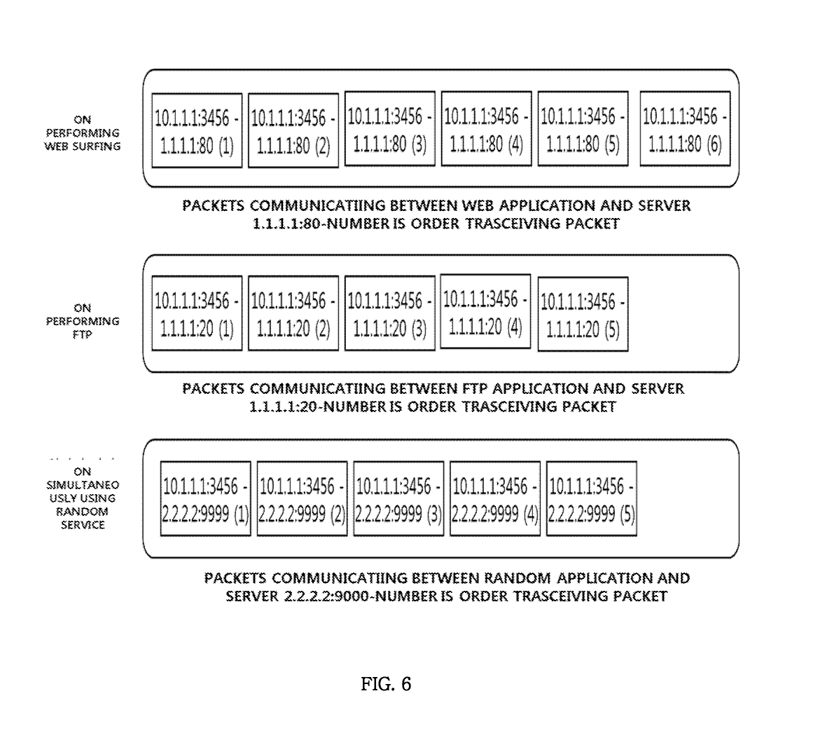

The packets shown in FIG. 6 are produced, on assuming communication with [80 PORT of 1.1.1.1 server 300], [20 PORT of 1.1.1.1 server 300], [9999 PORT of 2.2.2.2 server 300] at random wireless terminals 200 [10.1.1.1], on classifying for each PORT of the servers 300 (The ports of the wireless terminals 200 are randomly designated on connecting the network to the specific port of the server 300, and is randomly designated as 3456 in FIG. 6 because the connection never changes as long as it is connected).

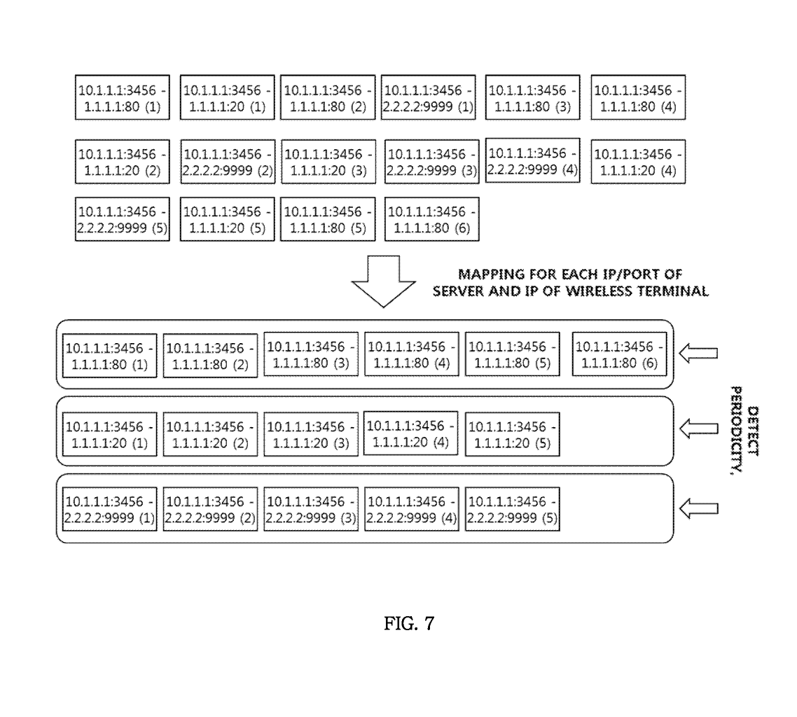

The specific applications at the wireless terminals 200 are connected to a plurality of servers 300 to perform each processor. At this time, the packets to be used pass base stations, pass the network processing apparatus such as GGSN or P-gateway, and are dispersed as a top drawing shown in FIG. 7 on collecting or capturing the packets at the collection unit. Therefore, the preprocessing unit 20 classifies these packets for each the IP and PORT as a bottom drawing shown in FIG. 7 and therefore these packets may be produced as an original structure.

Further, the preprocessing unit 20 may classify the packets collected or captured by the collection unit for each IP/PORT of the servers 300 and IP of the wireless terminals 200. To this end, it must know whether which address is the IP of the servers 300 and is the IP of the wireless terminals 200. Therefore, the preprocessing unit 20 may check whether which one of Source IP or Destination IP of the packets is the wireless terminals 200 IP and may determine whether which one of Source IP or Destination IP of the packets is the servers 300 IP by band information of the wireless terminals 200 IP at a wireless network to be analyzed.

Further, in the present invention, the preprocessing unit 20 filters network control packets of a plurality of packets to be collected or captured by the collection unit 10 and further excludes the filtered control packets.

In this case, the network control packets may include at least one of TCP connection packets, network connection termination packets, resetting packets, and acknowledgement packets.

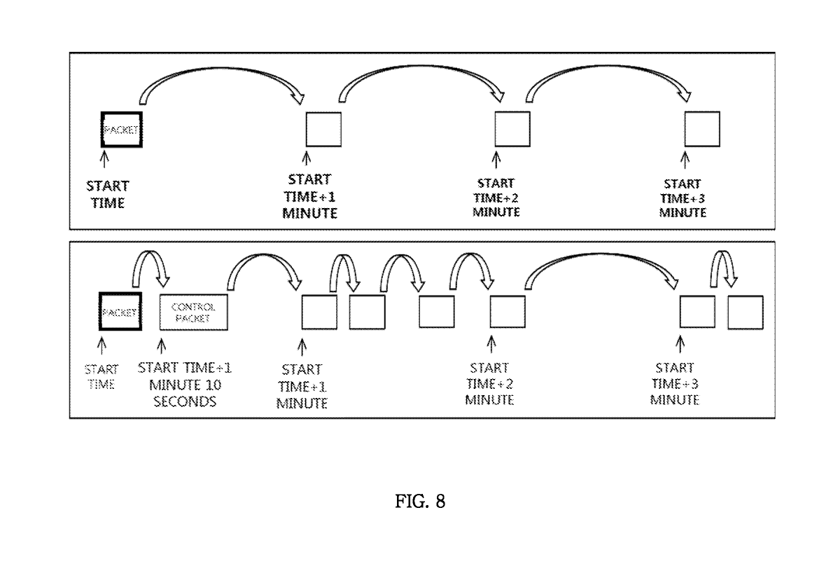

FIG. 8 shows that the control packets are included in the packets collected or captured by the collection unit 10.

That is, on assuming that the specific applications produces Keep Alive messages at 1 minute intervals, the wireless terminals 200 is ideally communicated with the servers 300 as patterns such as the top drawing shown in FIG. 8, but various control packets are really mixed, according to the state of the communication network, as the bottom drawing shown in FIG. 8. In this state, because it may not grasp periods of the packets directly sending from the wireless terminals 200 to the servers 300 by collection or capture time of the packets, the preprocessing unit 20 removes all the control packets such that the packets only, that the wireless terminals 200 really requests to the servers 300 and transceives from/to them, remain.

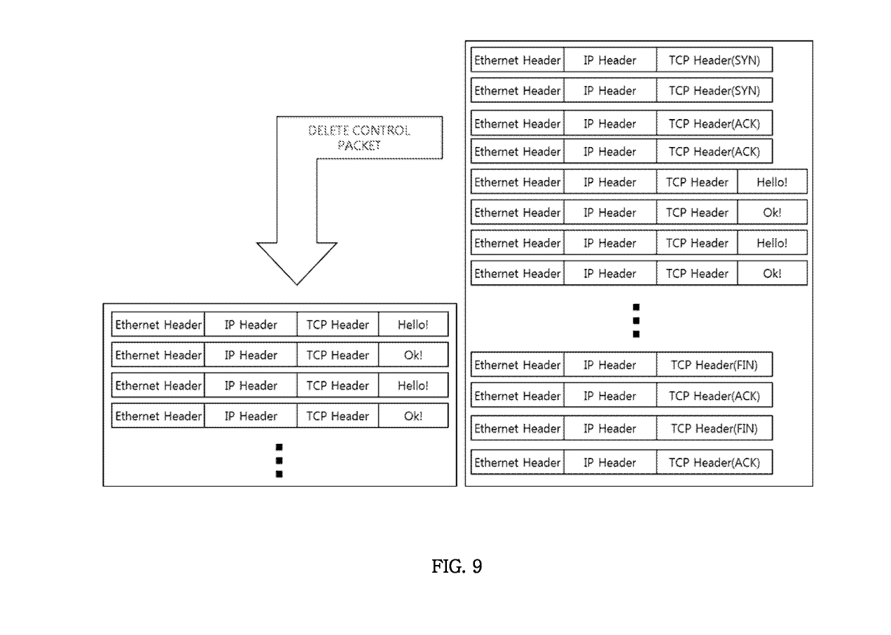

In an example shown in FIG. 9, when the preprocessing unit 20 filters the control packets, the specific wireless terminal 200 firstly sends “hello!” and receives “ok!” at 5 minutes intervals on connecting to the specific server 300 and all the packets that use to send “hello!” and receive “ok!” have a state before removing the control packets shown in FIG. 9.

That is, referring to FIG. 9, when a user merely sends “hello!” and receive “ok!”, the packets are used for connection setting SYN, ACK and connection termination FIN, ACK. When the packets are midway lost, various control packets such as the packets for requesting retransmission and for connecting again are interposed midway, wherein because these packets are irrespective of periodicity detection, the preprocessing unit 20 removes all the control packets.

In order to know whether the packets are the control packets, the preprocessing unit 20 may determine the packets having no contents as the control packets.

The modeling processing unit 30 in an embodiment of the present invention processes at least one data modeling and groups for each packet generation patterns, for the packets mapped through the preprocessing unit 20.

In the present invention, the modeling processing unit 30 may process data modeling using at least one of a polling model grouping for a period of changing ports of the wireless terminals 200, a time model grouping the packets included in predefined time interval, and a region model grouping according to packet generation distribution, and modeling schemes for grouping the packets except the proposed modeling schemes may be added.

That is, the modeling processing unit 30 determines the periodicity or not after firstly grouping the packets through the polling modeling, determines the periodicity or not after secondly grouping the packets through the time modeling in case of having non-periodicity, and determines the periodicity or not after thirdly grouping the packets through the region modeling in case of having non-periodicity, and therefore the modeling may be added stage by stage.

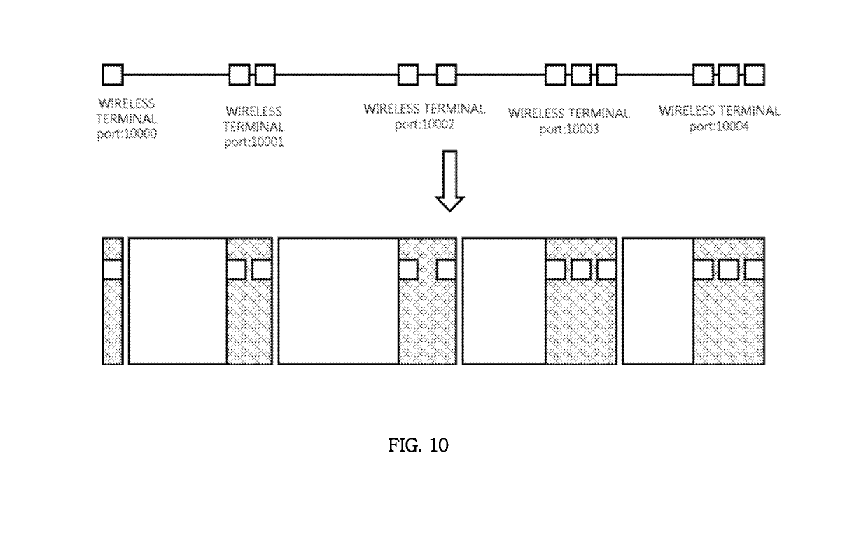

FIG. 10 shows an example grouping the packets by polling modeling in the modeling processing unit 30.

The polling model, which is corresponded to communication schemes having typical polling types, is adaptable in the case that the wireless terminals 200 terminate the transmission after periodically communicating with the servers 300 and transceiving data.

Since the ports of the wireless terminals 200 are changed whenever connecting and disconnecting the network, the modeling processing unit 30 groups the given packets for a period of changing the ports of the wireless terminals 200.

When the packets are present as the top drawing shown in FIG. 10, the groups are formed as the bottom drawing on successively grouping the packets among the same ports. Each of the grouped data model may become periodic when total time, duration time or period thereof are similar, and it may be predicted as the polling when the port of each data model is continuously changed.

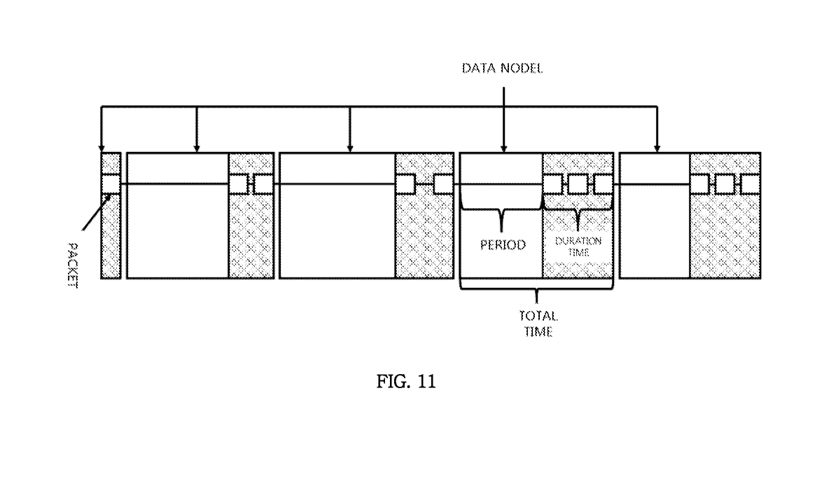

FIG. 11 shows one embodiment showing data models grouping the packets according to the embodiment of the present invention.

Each data model may include the packets that belong to the model, and additional information, that is, period, duration time and total time thereof. The period means time difference between a last packet of the previous data model and a first model of a current data model, the duration time means time difference between a first packet and the last packet that belongs to the current data model, and the total time means a value that adds the period to the duration time.

Therefore, the period, the duration time and the total time may be illustrated as a comparison value for determining similarity for each data model.

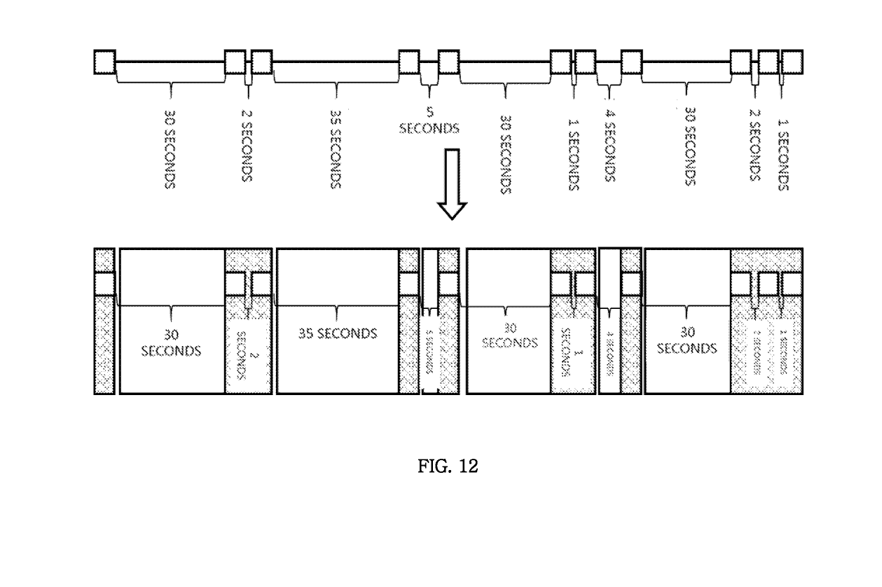

FIG. 12 shows one embodiment grouping the packets by time modeling in the modeling processing unit 30.

The time modeling groups timely adjacent packets into one data model, and the modeling processing unit 30 may process the time modeling by controlling to be belonged to a same model when the current packet and next packet are within a designated time interval and a different model when the current packet and next packet are not within the designated time interval, after designating random time intervals.

When the time intervals with the previous packet are shown as the top drawing shown in FIG. 12 (in the case that the time intervals with the previous packet to be designated as the same group are within 2 seconds), data models in the bottom drawing are produced.

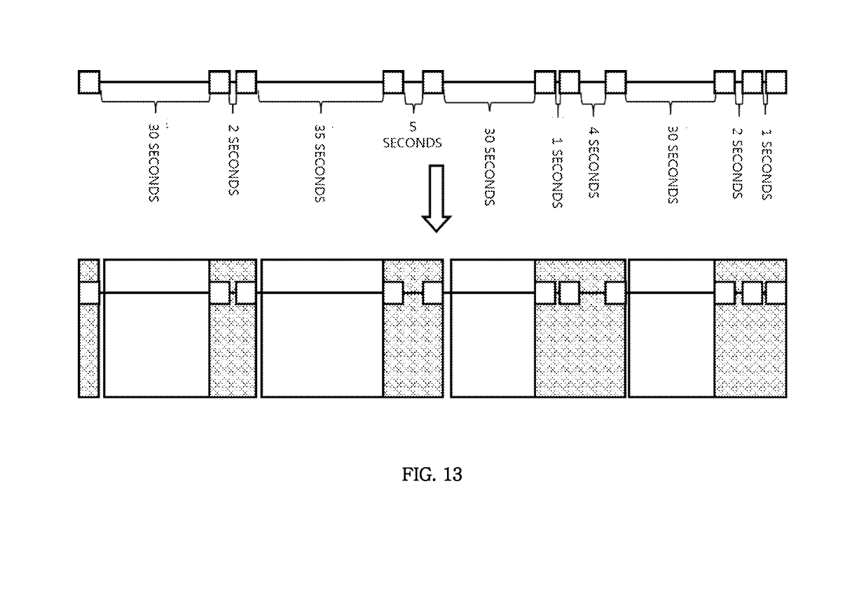

FIG. 13 shows one embodiment grouping the packets by region modeling in the modeling processing unit 30.

The time modeling groups the packets based on the designated random time, while the region modeling groups the packets to be similarly distributed. The time modeling described above is mechanically rigid modeling that makes slots by the specific time and determines the periodicity according to repetition or not of the packets within the slots, while the region modeling, that widely finds the periodicity, finds the periodicity by sorting with the packets to be relatively apart after binding the packets to be relatively stacked.

The methods for regionally binding the packets to be distributed are various, and one of them includes three values, that is, minimum duration time (the duration time of the packets bound within one group), a threshold value for branching into another group and maximum duration time. When the duration time satisfies the following conditions, it may be regarded as new models.

The duration time>=the minimum duration time and the duration time>=cumulative duration time*threshold value) or (the cumulative duration time>=maximum duration time

Referring to FIG. 13, the packets are grouped as the bottom drawing in FIG. 13 on setting a minimum duration range to 10 seconds, on setting a threshold value to 2 times, and on setting a maximum duration range to 10 minutes.

A pattern detection unit 40 in one embodiment of the present invention detects similar data models within the margin of defined error as repetition generation pattern types by mutual lengths (the sum of time difference between the last packet of the previous data model and the first packet of the current data model and time difference between the first packet and last packet that belong to the current data model or time difference between the last packet of the previous data model or the first packet of the current data model or time difference between the first packet and last packet that belong to the current data model) between a plurality of data models grouped for each packet generation pattern by the modeling processing unit 30.

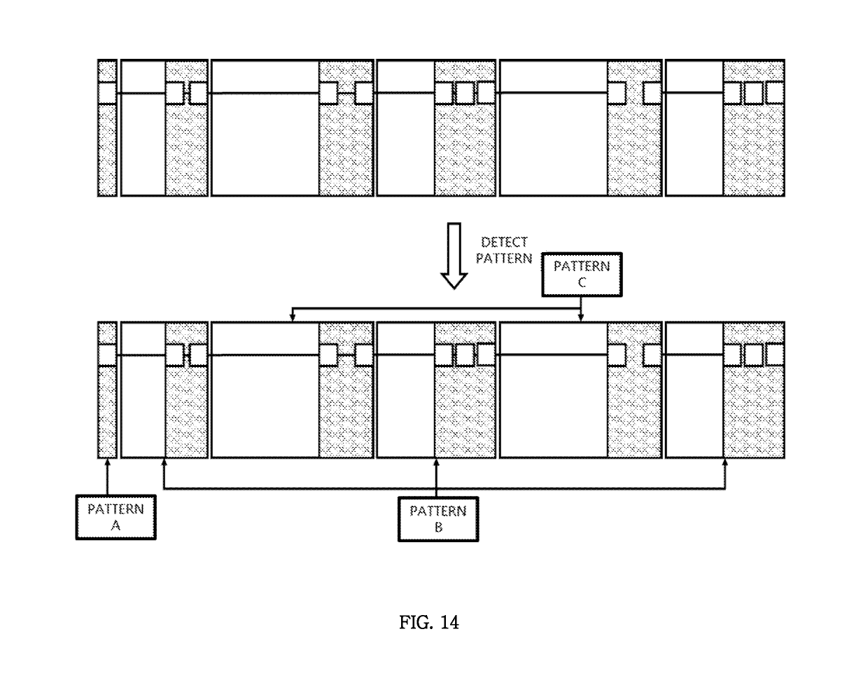

FIG. 14 to FIG. 21 are one embodiment showing pattern detecting processes according to an embodiment of the present invention.

Referring to FIG. 14, the pattern detection unit 40 may detect patterns (pattern A, pattern B, pattern C, etc.) among the data models having similar lengths (the total time summing time difference between the last packet of the previous data model and the first packet of the current data model and time difference between the first packet and last packet that belong to the current data model or time difference between the last packet of the previous data model and the first packet of the current data model) for data models grouped by the modeling processing unit 30.

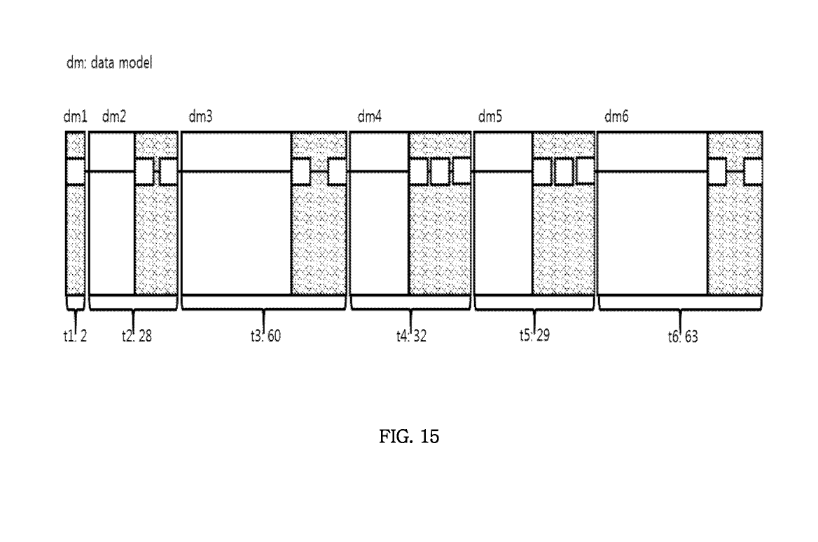

Referring to FIG. 15, the pattern detection unit 40 designates a first data model as ID 1, compares total time values t from first data model to last data model in order, increases ID by 1 in the case that t value of the previous model is not similar to it of next model, and may determine whether the next model is similar based on average values of t of the same ID unit in the case that t value of the previous model is similar to it of next model.

Referring to FIG. 15, on assuming an error range as 20%, because the lengths of t1 and t2 are not similar, a data model (dm) 2 is designated as ID 2. Because the lengths of t2 and t3 are not similar, a dm 3 is designated as ID 3. Because the lengths of t3 and t4 are not similar, a dm 4 is designated as ID 4. Because the lengths of t4 and t5 are similar, a dm 5 is designated as the same ID 4. Because t4 and t5 have the same ID and therefore there is no similarity on seeing the similarity with t6 using an average value of them, a dm6 is designated as ID 5 (wherein, similarity determination for two values may use [(n−1)−error<=n<=(n−1)+error].

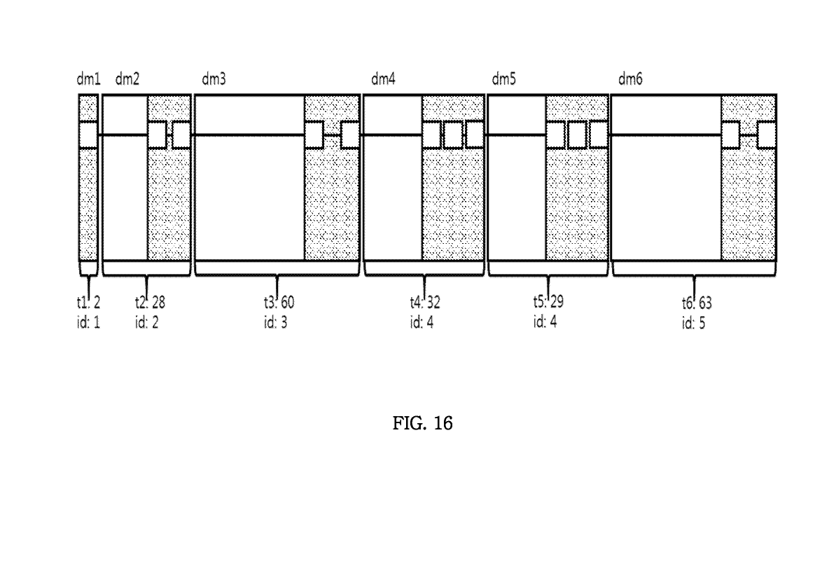

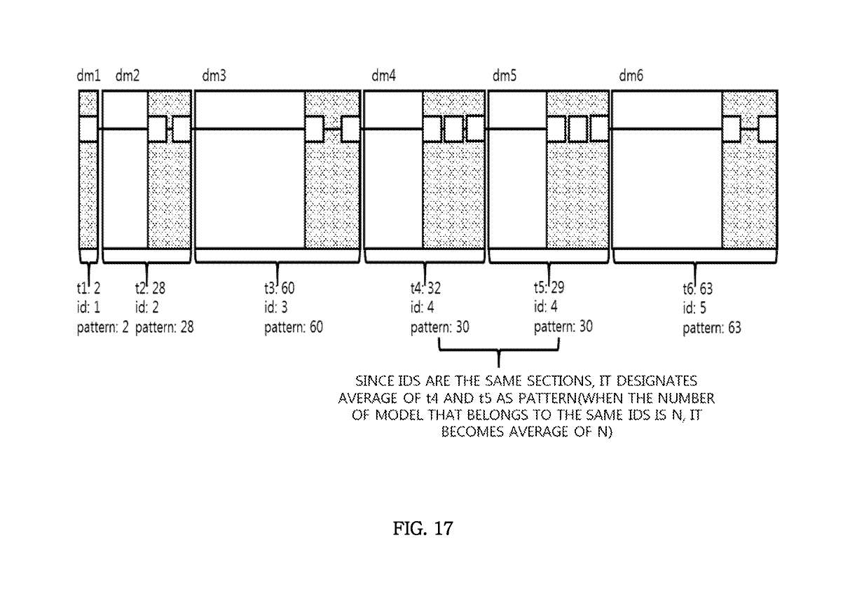

FIG. 16 shows a type finally giving ID after processes of FIG. 15, and FIG. 17 shows that the average values of the total time t for data models having the same ID are designated as the patterns of the corresponding data model.

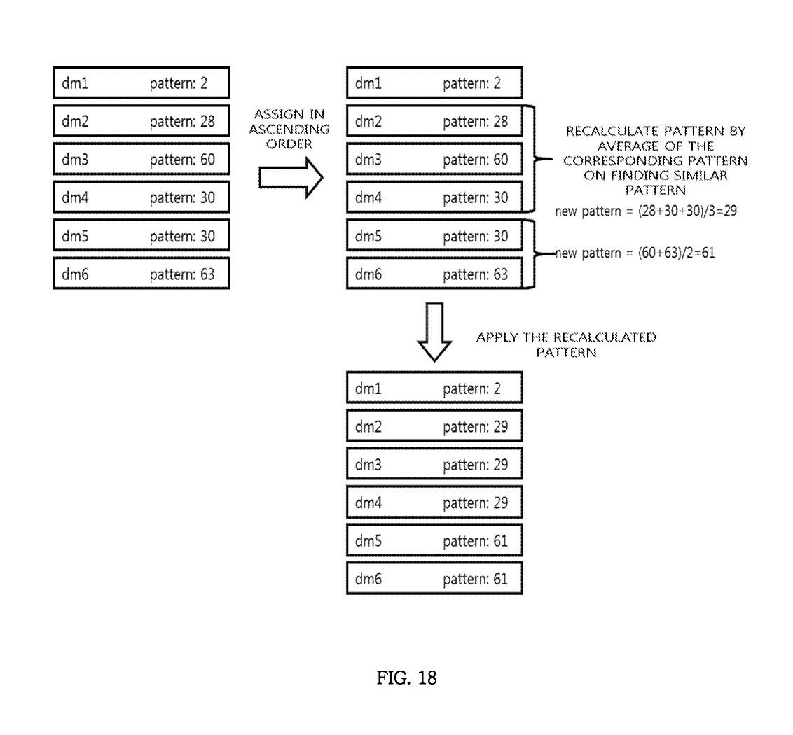

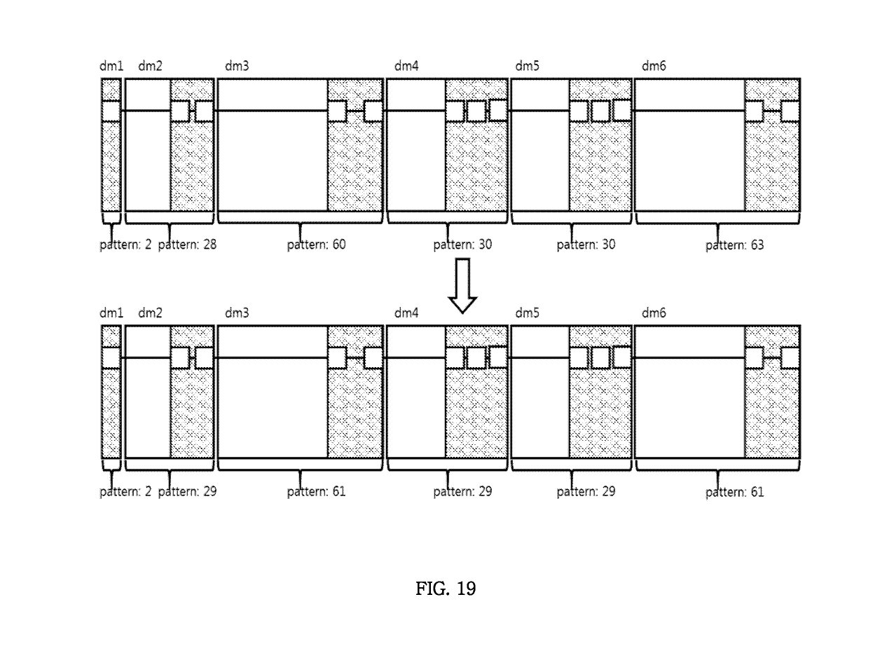

Then, the pattern detection unit 40 assigns each detected patterns shown in FIG. 18 in ascending order and combines similar patterns, updates pattern information of the corresponding data models, and finally detects 3 kinds of the patterns (that is, total time 2, total time 29 and total time 61) shown in FIG. 19.

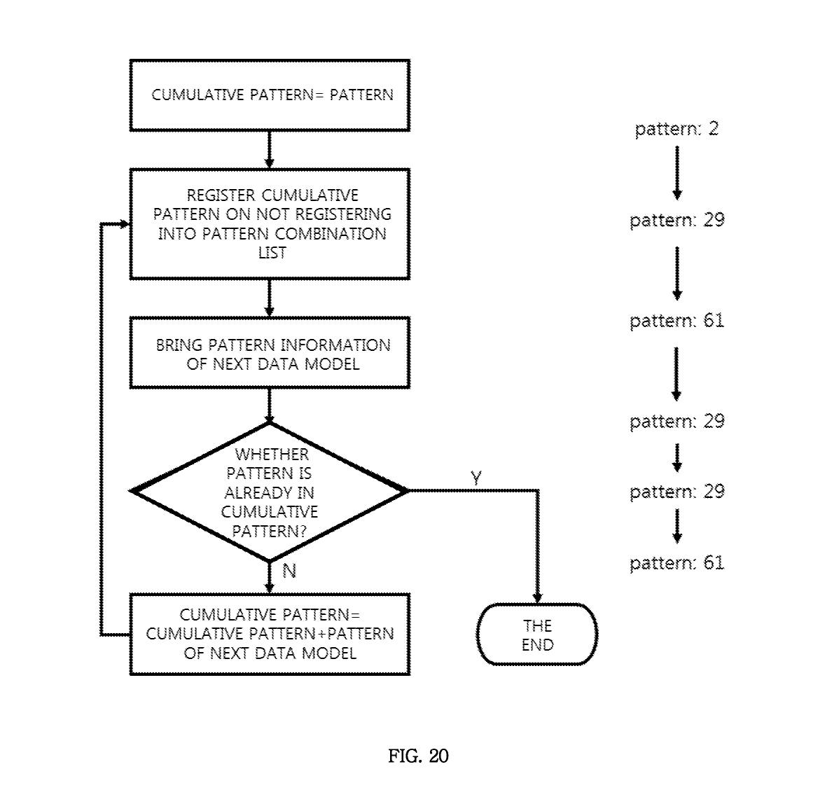

Further, the pattern detection unit 40 sequentially uses a method described in FIG. 20 for each data model to find combination of the patterns that is able to find from the given data models, and the found patterns may be managed as lists of the pattern combination.

That is, referring to FIG. 20, in the pattern detection unit 40, it adds total time 2 because there is no the total time 2 in the list, it adds the total time 2:the total time 29 because there are no the total time 2:the total time 29 in the list, it adds the total time 2:the total time 29:the total time 61 because there are no the total time 2:the total time 29:the total time 61 in the list, it terminates because the total time 29 is present in a cumulative pattern, it adds the total time 29 because there is no the total time 29 in the list, it adds the total time 29:the total time 61 because there are no the total time 29:the total time 61 in the list, it terminates because the total time 29 is present in the cumulative pattern, it adds the total time 61 because there is no the total time 61 in the list, it adds the total time 61:the total time 29 because there are no the total time 61:the total time 29 in the list, it terminates because the total time 29 is present in the cumulative pattern, it terminates because the total time 29 is present in the list, and it terminates because the total time 61 is present in the list, and therefore it produces total 7 pattern combination lists such as [the total time 2, the total time 2:the total time 29, the total time 2:the total time 29:the total time 61, the total time 29, the total time 29:the total time 61, the total time 61, the total time 61:the total time 29] as finally found pattern combination lists.

The periodicity detection unit 50 in one embodiment of the present invention determines periodic section when the repetition generation pattern types detected by the pattern detection unit 40 are successively generated above n times (n=one numeral of 2, 3, 4 . . . n) and the sections successively generated above n times occupy above predetermined rate to the total unit.

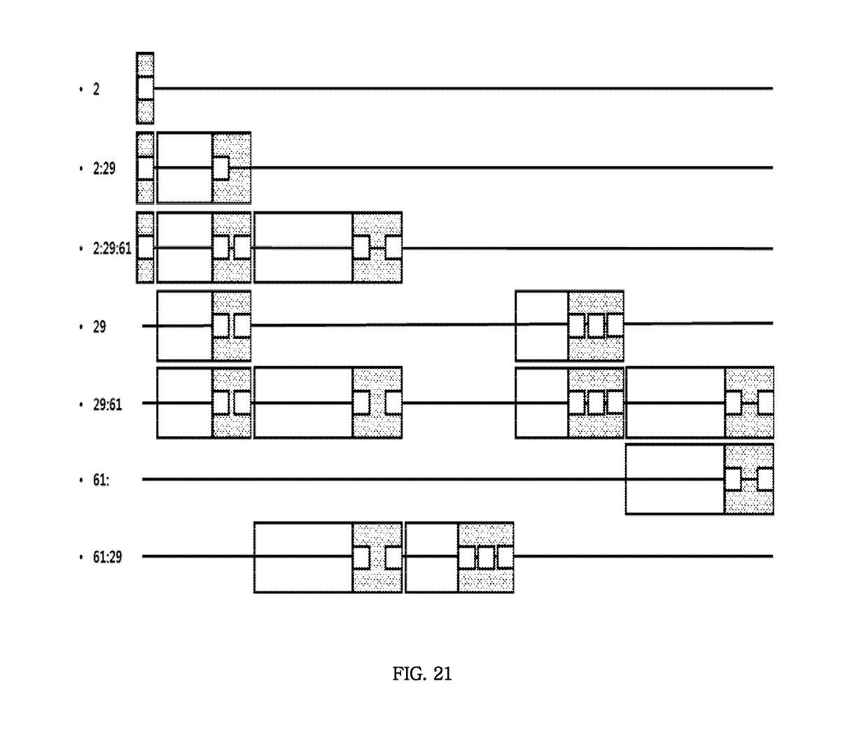

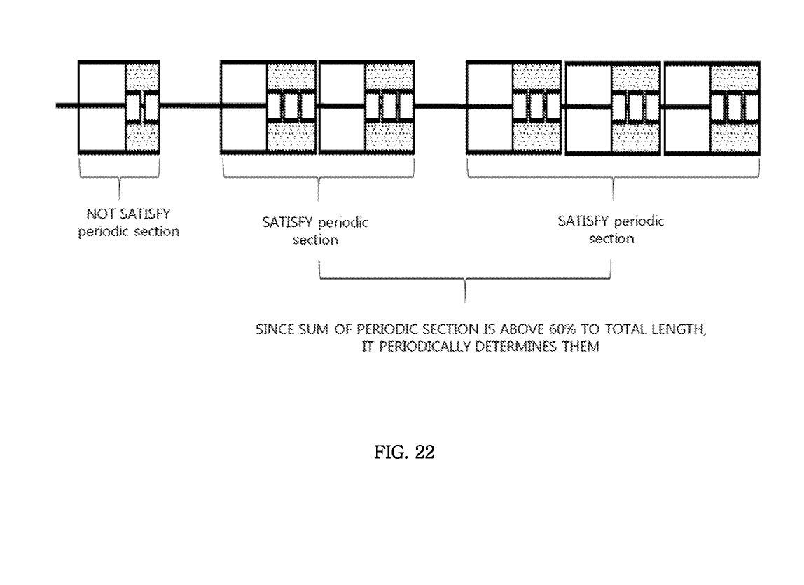

That is, the periodicity detection unit 50 checks whether the patterns produced through the pattern detection unit 40 are distributed for each the pattern combination at how many region as shown in FIG. 21, and determines periodic section when at least one series of patterns are successively generated above n times (n=one numeral of 2, 3, 4 . . . n) and decides the periodic section when these periodic section occupy above predetermined rate to the total time as shown in FIG. 22.

Of course, it may decide the periodic section when at least one series of patterns are politically generated above n times (n=one numeral of 2, 3, 4 . . . n) successively, but it is more preferable to decide the periodic section when these periodic section occupy above predetermined rate to the total time.

Further, the periodicity detection unit 50 analyzes the packets assigned at the sections determined as the periodic section and therefore may determine whether the corresponding unit is a polling periodic unit or a Keep Alive unit.

The periodicity detection unit 50 determines the packets stored into the slots present at the sections to be periodically determined as the polling periodic section when the ports of the packets corresponding to the wireless terminals 200 are successively changed, and determines the packets stored into the slots present at the sections to be periodically determined as the Keep Alive periodic unit in case of meeting one of the case that the ports of the packets stored into the slots present at the sections to be periodically determined are not changed, or the case that the number of transmission/receipt packets is below n or the case that the sizes of the transmission/receipt packets are constant. To this end, the periodicity detection unit 50 may further includes a polling determination unit or a Keep Alive determination unit. The periodicity detection unit 50 controls the polling determination unit or Keep Alive determination unit to determine the polling sections or the periodic section.

The check unit 60 in the embodiment of the present invention checks domain names suitable for an IP of the server 300 corresponding to the periodic section using IP and domain name tables derived by DNS (Domain Name System) protocol analysis.

That is, the periodicity detection unit 50 detects information that is periodic for IP/PORT of the specific servers 300 finally and detects what the period is. Since this may not know whether the specific servers 300 is which server 300, it is possible to check the domain names derived by DNS Protocol analysis firstly to acquire additional information for the server 300 and to specify the specific server 300.

For example, when the server 300 called 1.1.1.1:80 is periodically detected and, on checking DNS tables, the corresponding IP is “www.naver.com”, it may estimate it as NAVER service.

In the present invention, the entire or some function of configurations included in the device 100 for detecting periodicity may be implemented by a program or program set, and each configuration may include at least one servers or devices.

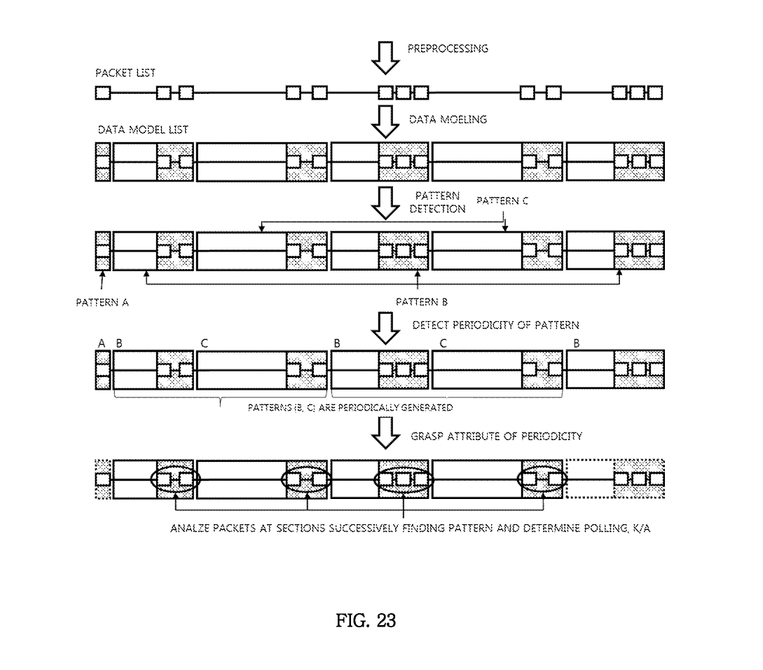

FIG. 23 schematically shows the entire processes according to an embodiment of the present invention, processes at least one data modeling for the preprocessed packets and groups the processed data modeling for each packet generation pattern, detects the repetition generation pattern types of a plurality of data models grouped for each packet generation pattern, determines the periodic section in case of meeting one of the cases that the detected repetition generation pattern types are successively generated above n times (n=one numeral of 2, 3, 4 . . . n) and that the sections successively generated above n times occupy above predetermined rate to the total time interval of the packets, and analyzes the packets, having the periodic section, in which the patterns are successively found and determines the polling sections and Keep Alive sections.

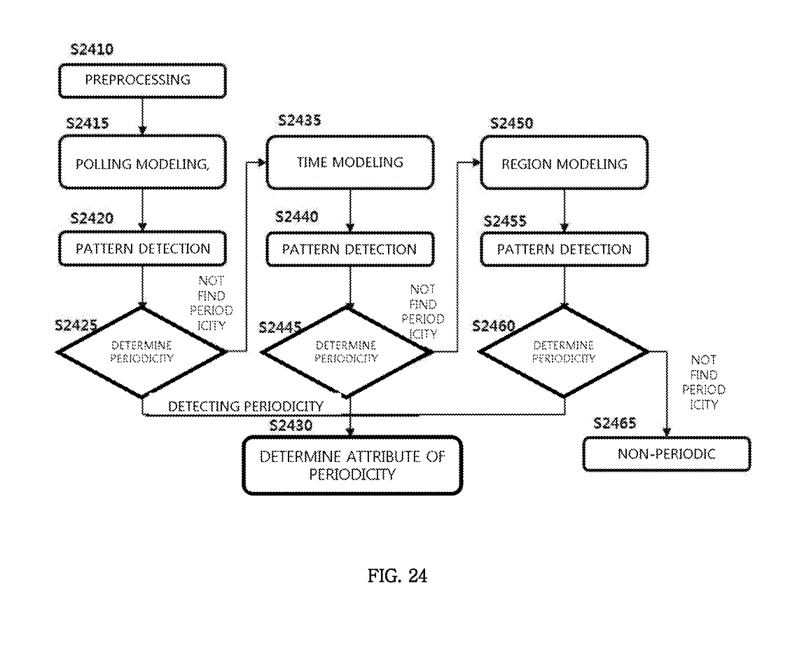

FIG. 24 shows the processes for detecting periodicity according to an embodiment of the present invention.

The device 100 for detecting periodicity collects or captures a plurality of packets for mutually transceiving between a plurality of wireless terminals 200 and servers 300 in a communication network by the collection unit 10, and connects the packets and packet collection or capture time information collected or captured by the collection unit 10 to the subject and the object of transceiving each packet, that is, each wireless terminals 200 IP and servers 300 IP/PORT and maps the connected them, by the preprocessing unit 20 (S2410).

At this time, the preprocessing unit 20 in the device 100 for detecting periodicity filters whether control packets are included in packets to be collected or captured by the collection unit 10 and excludes the filtered control packets in case of including the control packets.

After step S2410, the device 100 for detecting periodicity performs first data modeling (for example, polling modeling) by the modeling processing unit 30 and groups the performed data modeling for each packet generation pattern (S2415).

Then, the device 100 for detecting periodicity detects similar data models within the margin of defined error as repetition generation pattern types by mutual lengths (the sum of time difference between the last packet of the previous data model and the first packet of the current data model and time difference between the first packet and last packet that belong to the current data model or time difference between the first packet and last packet that belong to the current data model) between a plurality of data models grouped for each packet generation pattern by the pattern detection unit 40 (S2420).

The periodicity detection unit 50 determines the periodic section when the detected repetition generation pattern types are successively generated above n times (n=one numeral of 2, 3, 4 . . . n) and a sum of time intervals of the repetition generation pattern types successively generated above n times occupy above predetermined rate to the total time interval (S2425).

On finding the periodicity at step S2425, the periodicity detection unit 100 determines the packets stored into the slots present at the sections to be periodically determined as the polling periodic section when the ports of the packets corresponding to the wireless terminals 200 are successively changed, and determines the packets stored into the slots present at the sections to be periodically determined as the Keep Alive periodic unit in case of meeting one of the case that the ports of the packets stored into the slots present at the sections to be periodically determined are not changed, or that the number of transmission/receipt packets is below n or the case that the sizes of the transmission/receipt packets are constant (S2430).

On not finding the periodicity at step S2425, the device 100 for detecting periodicity performs second data modeling (for example, time modeling) by the modeling processing unit 30 and groups the performed data modeling for each packet generation pattern (S2435).

The device 100 for detecting periodicity detects similar data models within the margin of defined error as repetition generation pattern types by mutual lengths between a plurality of data models grouped for each packet generation pattern by the pattern detection unit 40 (S2440).

The periodicity detection unit 50 determines the periodic section when the detected repetition generation pattern types are successively generated above n times (n=one numeral of 2, 3, 4 . . . n) and the sum of time intervals of the repetition generation patterns successively generated above n times occupy above predetermined rate to the total time interval (S2445).

On finding the periodicity at step S2445, the device 100 for detecting the periodicity performs the step S2430.

On not finding the periodicity at step S2445, the device 100 for detecting periodicity performs third data modeling (for example, region modeling) by the modeling processing unit 30 and groups the performed data modeling for each packet generation pattern (S2450).

The device 100 for detecting periodicity detects similar data models within the margin of defined error as repetition generation pattern types by mutual lengths between a plurality of data models grouped for each packet generation pattern by the pattern detection unit 40 (S2455).

The periodicity detection unit 50 determines the periodic section when the detected repetition generation pattern types are successively generated above n times (n=one numeral of 2, 3, 4 . . . n) and the sum of time intervals of the repetition generation pattern types successively generated above n times occupy above predetermined rate to the total interval (S2460).

On finding the periodicity at step S2460, the device 100 for detecting the periodicity performs the step S2430.

On not finding the periodicity at step S2460, the device 100 for detecting the periodicity performs fourth data modeling by the modeling processing unit 30 or sets non-periodic section (S2465).

The data modeling at steps S2415, S2435 and S2450 may be added or deleted, and the order of them may be changed.

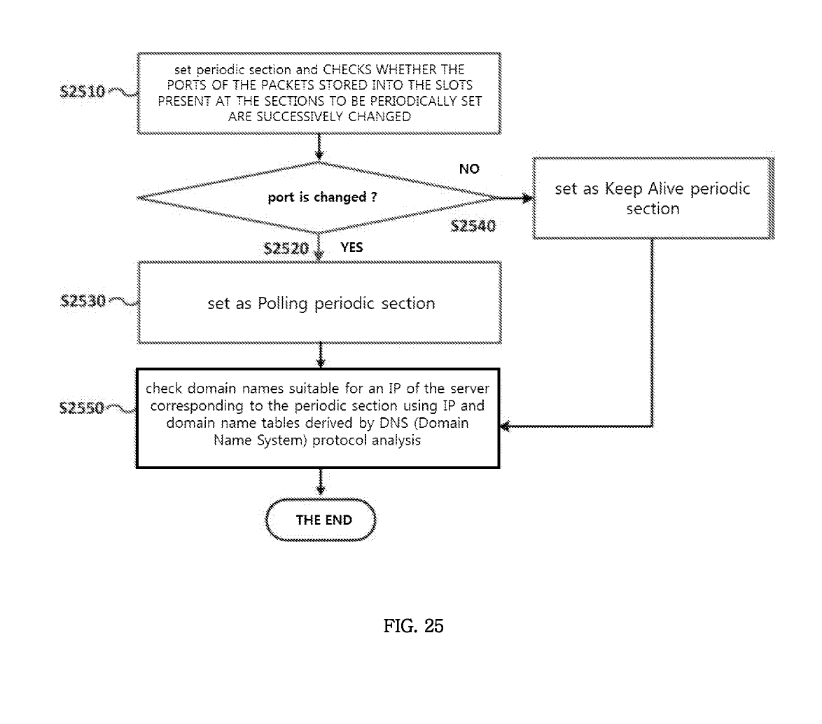

FIG. 25 shows the periodicity detecting processes such as polling or keep-alive according to an embodiment of the present invention.

The periodicity detection unit 50 of the device 100 for detecting the periodicity analyzes the packets stored into the slots present at the sections to be set as the periodic section and checks whether the ports of the packets corresponding to the wireless terminals 200 are successively changed (S2510).

On checking step S2510, when the ports of the packets stored into the slots present at the periodic section are successively changed (S2520), the periodicity detection unit 50 of the device 100 for detecting the periodicity sets the periodic section to the polling periodic section (S2530).

When the ports of the packets stored into the slots present at the periodic section are not successively changed (S2540), the periodicity detection unit 50 of the device 100 for detecting the periodicity sets the periodic section to the Keep Alive periodic section.

The case setting the periodic section to the Keep Alive periodic section is not shown in the drawings, but the periodicity detection unit 50 of the device 100 for detecting the periodicity may set the Keep Alive periodic section even when the number of the transmission/receipt packets stored into slots present at the sections to be periodically determined is below the predetermined number or the sizes of the transmission/receipt packets are constant.

Then, the check unit 60 of the device 100 for detecting the periodicity checks domain names suitable for an IP of the server 300 corresponding to the periodic section using IP and domain name tables derived by DNS (Domain Name System) protocol analysis (S2550).

According to an embodiment of the present invention, periodic connection sections for a specific server for each application installed at the wireless terminal are detected, it determines whether the sections are polling sections or Keep Alive sections, and therefore unnecessary performance causing the network load may be blocked or controlled for each application, thereby to optimally use the network at the wireless terminal.

According to another embodiment of the present invention, mobile-service company's network expansion cost may be minimized by optimization of network use.

According to further another embodiment of the present invention, on optimizing network use, it is possible to minimize dissatisfaction for the wireless terminal's user caused by data communication delay, etc. and to greatly reduce battery consumption for the wireless terminal.

What is claimed is:

1. A device for detecting periodicity, comprising:
a collection unit for collecting or capturing a plurality of packets for mutually transceiving between a plurality of wireless terminal and a plurality of servers through a communication network;
a preprocessing unit for processing a mapping by connecting the packets collected or captured by the collection unit and packet collection time information or packet capture time information to each wireless terminal's IP and server's IP/PORT;
a modeling processing unit for grouping for each packet generation pattern by processing at least one data modeling for the mapped packets;
a pattern detection unit for detecting repetition generation pattern types from a plurality of data models grouped for each packet generation pattern, using similar data models within the margin of defined error by mutual lengths of the data models; and
a periodicity detection unit for determining periodic sections when the detected repetition generation pattern types are successively generated above n times or time intervals of the sections successively generated above n times occupy above a predetermined rate to a total time.

2. The device for detecting periodicity according to claim 1, further comprising a Keep Alive determination unit for determining the periodic section as Keep Alive periodic section based on at least one of whether the ports of the packets changing which stored into the slots present in the periodic sections, the number of the packets to be transceived, and the sizes of the packets to be transceived.

3. The device for detecting periodicity according to claim 2, wherein the Keep Alive determination unit determines the periodic section as the Keep Alive periodic section when the ports of the packets stored into the slots present in the periodic sections are not changing or the number of the packets to be transceived is below predetermined number or the sizes of the packets to be transceived are constant.

4. The device for detecting periodicity according to claim 1, further comprising a polling determination unit for determining the periodic section as polling periodic section based on the ports of the packets stored into the slots present at the periodic sections.

5. The device for detecting periodicity according to claim 3, wherein the polling determination unit determines the periodic section as polling periodic section when the ports of the packets stored into the slots present at the periodic sections are successively changed.

6. The device for detecting periodicity according to claim 1, wherein the preprocessing unit filters network control packets of a plurality of packets to be collected or captured by the collection unit and excludes the filtered packets, and the network control packets include at least one of TCP connection packets, network connection termination packets, resetting packets, and acknowledgement packets.

7. The device for detecting periodicity according to claim 1, wherein the data modeling processing unit processes data modeling using at least one of a polling model grouping for a period of changing ports of the wireless terminals, a time model grouping the packets included in predefined time interval, and a region model grouping according to packet generation distribution.

8. The device for detecting periodicity according to claim 1, further comprising a check unit for checking domain names suitable for an IP of the servers corresponding to the periodic section using IP and domain name tables derived by DNS protocol analysis.

9. The device for detecting periodicity according to claim 1, wherein the mutual lengths are any one of the sum of time difference between the last packet of the previous data model and the first packet of the current data model and time difference between the first packet and last packet that belong to the current data model, time difference between the last packet of the previous data model and the first packet of the current data model or time difference between the first packet and last packet that belong to the current data model.

10. A method for detecting periodicity, comprising:
collecting or capturing a plurality of packets for mutually transceiving between a plurality of wireless terminal and a plurality of servers through a communication network;
mapping the packets and packet collection or capture time information collected or captured by the collection unit to each wireless terminal's IP and server's IP/PORT by connecting them;
processing at least one data modeling by grouping for each packet generation patterns, for the mapped packets;
detecting similar data models within the margin of defined error as repetition generation pattern types by mutual lengths between a plurality of data models grouped for each packet generation pattern; and
determining periodic sections when the detected repetition generation pattern types are successively generated above n times or a sum of time intervals of the repetition generation pattern types successively generated above n times occupy above a predetermined rate for total time.

11. The method for detecting periodicity according to claim 10, further comprising determining the periodic section as Keep Alive periodic section based on at least one of changing of the ports of the packets stored into the slots present at the periodic sections, the number of the packets to be transceived, and the sizes of the packets to be transceived.

12. The method for detecting periodicity according to claim 11, wherein the determining the periodic section as the Keep Alive periodic section includes determining the periodic section as the Keep Alive periodic section when the ports of the packets stored into the slots present at the periodic section are not changing or the number of the packets to be transceived is below predetermined number or the sizes of the packets to be transceived are constant.

13. The method for detecting periodicity according to claim 10, further comprising determining the periodic section as polling periodic section based on the ports of the packets stored into the slots present at the periodic section.

14. The method for detecting periodicity according to claim 13, wherein the determining the periodic section as polling periodic section includes determining the periodic section as polling periodic section when the ports of the packets stored into the slots present at the periodic sections are successively changed.

15. The method for detecting periodicity according to claim 10, further comprising:
filtering network control packets of a plurality of packets to be collected or captured; and
excluding the filtered packets.

16. The method for detecting periodicity according to claim 15, wherein the network control packets include at least one of TCP connection packets, network connection termination packets, resetting packets, and acknowledgement packets.

17. The method for detecting periodicity according to claim 10, wherein the grouping for each packet generation patterns include processing data modeling using at least one of a polling model grouping for a period of changing ports of the wireless terminals, a time model grouping the packets included in predefined time interval, and a region model grouping according to packet generation distribution.

18. The method for detecting periodicity according to claim 10, further comprising checking domain names suitable for an IP of the servers corresponding to the periodic section using IP and domain name tables derived by DNS protocol analysis.

19. The method for detecting periodicity according to claim 10, wherein the mutual lengths are any one of the sum of time difference between the last packet of the previous data model and the first packet of the current data model and time difference between the first packet and last packet that belong to the current data model, time difference between the last packet of the previous data model and the first packet of the current data model or time difference between the first packet and last packet that belong to the current data model.

20. A computer-readable recording medium for recording programs for causing a computer to execute the method described in claim 10.
